(19) United States
(12) Patent Application Publication
(10) Pub. No.: US 2009/0287489 A1
(43) Pub. Date: Nov. 19, 2009

(54) SPEECH PROCESSING FOR PLURALITY OF USERS

(75) Inventor: Sagar Savant, Sunnyvale, CA (US)

Correspondence Address: FOLEY & LARDNER LLP, 111 HUNTINGTON AVENUE, 26TH FLOOR, BOSTON, MA, 02199-7610, US

(73) Assignee: Palm, Inc.

(21) Appl. No.: 12/121,554

(22) Filed: May 15, 2008

(51) Int. Cl. G10L 15/00

(52) U.S. Cl. 704/246; 704/E15.001

(57) ABSTRACT

A mobile communication device configured to communicate over a wireless network has an audio processing circuit that is adaptable based on a pattern of the speaker's voice to provide improved audio quality and intelligibility. The audio processing circuit is configured to receive a voice signal from an individual speaker, to determine a pattern associated with the speaker's voice, and to adjust a filter based on the determined pattern.

### FIELD

The present invention relates generally to the field of speech signal processing, and more particularly to adaptive filtering of a speech signal in a mobile communication device to improve quality of the speech.

### BACKGROUND

Mobile communications devices, such as mobile telephones, laptop computers, and personal digital assistants, can communicate with different wireless networks in different locations. Such devices can be used for voice communications, data communications, and combined voice and data communications. Such communications over the wireless networks generally subscribe to one or more established industry standards or guidelines, to ensure that such communications handled by various service providers that may be using different equipment, still meet an acceptable level of quality or indelibility to the end user. Guidelines for mobile communications have been established by such groups as the 3rd Generation Partnership Project (3GPP), and Cellular Telecommunications & Internet Association (CTIA).

Although audio responses perceptible to humans can range from 20 Hz to 20 kHz, it is generally accepted in voice telephony that a much narrower spectrum is sufficient for intelligible speech. For example, the public switched telephone network allocates a limited frequency range of about 300 to 3400 Hz to carry a typical phone call from a calling party to a called party. The audio sound can be digitized at an 8 kHz sample rate using 8-bit pulse code modulation (PCM).

Currently, mobile phone users may describe the audio experience on their device as “muddy” or “tinny,” depending upon the far end user's speech properties. Such perception is due at least in part to the use of a single static filter within the audio processing portion of the device, for all voice types (e.g., deep voices versus high pitched voices). The voiced speech of a typical adult male generally has a fundamental frequency between about 85 and 155 Hz, whereas the fundamental frequency for typical adult female is between about 165 and 255 Hz. Although the fundamental frequency of most speech falls below the bottom of the typical telephony voice frequency band, enough of the harmonic series will be present for the missing fundamental to create an impression of hearing the fundamental tone. The static filter is designed to pass a voice signal that may be somewhere in between different voice types.

One such standardized signal is defined by the International Telecommunication Union in ITU-T Recommendation P.50 (standard P.50 signal), The standard P.50 signal is described in the recommendation as an artificial voice, aimed at reproducing the characteristics of real speech over a bandwidth of 100 Hz to 8 kHz. The standard P.50 signal can be used for objective evaluation of speech processing systems and devices. Unfortunately, the variations in a speaker's spectral content between language, gender, and age do not necessarily match the standard P.50 signal. Therefore, a static filter solution results in limited audio quality and intelligibility.

### BRIEF DESCRIPTION OF THE DRAWINGS

The invention is described in more detail referring to the advantageous embodiments presented as examples and to the attached drawings, in which:

FIG. 1 is a front view of a mobile communication device, according to an exemplary embodiment;

FIG. 2 is a back view of a mobile communication device, according to an exemplary embodiment;

FIG. 3 is a block diagram of the mobile communication device of FIGS. 1 and 2, according to an exemplary embodiment;

FIG. 4 is a block diagram of an exemplary audio processing portion of a mobile communication device;

FIG. 5A is a graph illustrating an exemplary spectral response of an unfiltered speech signal processed by a mobile communication device;

FIG. 5B is a graph illustrating an exemplary spectral response of a filtered speech signal processed by a mobile communication device;

FIG. 6A is a block diagram of an alternative embodiment of the audio processing portion of a mobile communication device of FIG. 4;

FIG. 6B is a block diagram of another alternative embodiment of the audio processing portion of a mobile communication device of FIG. 4;

FIG. 6C is a block diagram of yet another alternative embodiment of the audio processing portion of a mobile communication device of FIG. 4;

FIG. 7 is a flowchart illustrating a system and method of processing an audio speech signal, according to an exemplary embodiment; and

FIG. 8 is a flowchart illustrating a system and method of determining a characteristic of a speech signal, according to an exemplary embodiment.

### DETAILED DESCRIPTION OF THE PREFERRED EMBODIMENTS

Some embodiments described herein may provide an adaptive filter having a spectral profile that can be varied depending on a speaker. In some embodiments, signal processing performs speaker categorization according to speech pattern matching of a voice signal to identify a preferred configuration of the adaptive filter for the speaker. In some embodiments, mobile phone users may enjoy an improved audio experience with enhanced intelligibility.

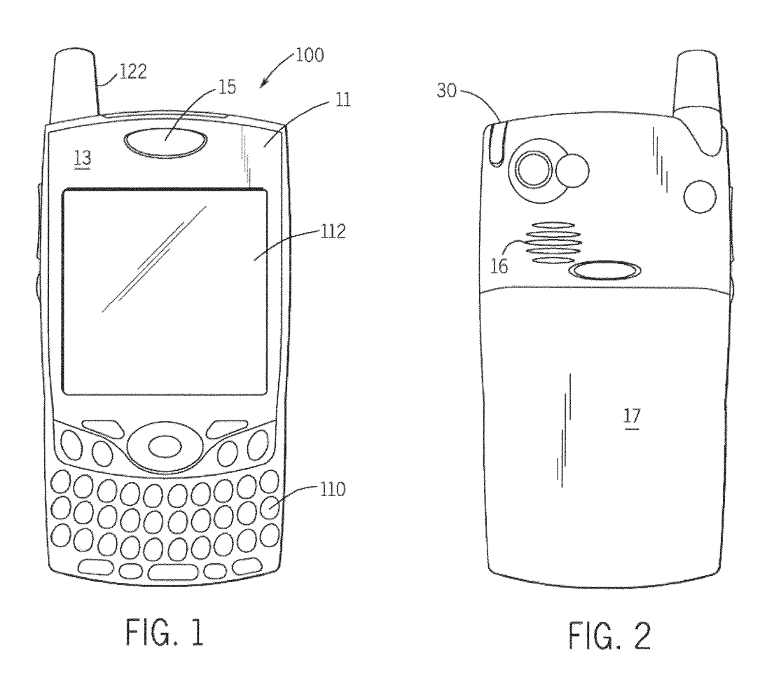

Referring first to FIG. 1, a mobile computing device 100 is shown. Device 100 is a smart phone, which is a combination mobile telephone and handheld computer having personal digital assistant functionality. The teachings herein can be applied to other mobile computing devices (e.g., a laptop computer) or other electronic devices (e.g., a desktop personal computer, etc.). Personal digital assistant functionality can comprise one or more of personal information management, database functions, word processing, spreadsheets, voice memo recording, etc. and is configured to synchronize personal information from one or more applications with a computer (e.g., desktop, laptop, server, etc.). Device 100 is further configured to receive and operate additional applications provided to device 100 after manufacture, e.g., via wired or wireless download, SecureDigital card, etc.

Device 100 comprises a housing 11 having a front side 13 and a back side 17 (FIG. 2). An earpiece speaker 15, a loudspeaker 16 (FIG. 2), and a user input device 110 (e.g., a plurality of keys 110) are coupled to housing 11. Housing 11 is configured to hold a screen in a fixed relationship above a user input device 110 in a substantially parallel or same plane. This fixed relationship excludes a hinged or movable relationship between the screen and plurality of keys in the fixed embodiment. Device 100 may be a handheld computer, which is a computer small enough to be carried in a typical front pocket found in a pair of pants, comprising such devices as typical mobile telephones and personal digital assistants, but excluding typical laptop computers and tablet PCs. In alternative embodiments, display 112, user input device 110, earpiece 15 and loudspeaker 16 may each be positioned anywhere on front side 13, back side 17, or the edges therebetween.

In various embodiments device 100 has a width (shorter dimension) of no more than about 200 mm or no more than about 100 mm. According to some of these embodiments, housing 11 has a width of no more than about 85 mm or no more than about 65 mm. According to some embodiments, housing 11 has a width of at least about 30 mm or at least about 50 mm. According to some of these embodiments, housing 11 has a width of at least about 55 mm.

In some embodiments, housing 11 has a length (longer dimension) of no more than about 200 mm or no more than about 150 mm. According to some of these embodiments, housing 11 has a length of no more than about 135 mm or no more than about 125 mm. According to some embodiments, housing 11 has a length of at least about 70 mm or at least about 100 mm. According to some of these embodiments, housing 11 has a length of at least about 110 mm.

In some embodiments, housing 11 has a thickness (smallest dimension) of no more than about 150 mm or no more than about 50 mm. According to some of these embodiments, housing 11 has a thickness of no more than about 30 mm or no more than about 25 mm. According to some embodiments, housing 11 has a thickness of at least about 10 mm or at least about 15 mm. According to some of these embodiments, housing 11 has a thickness of at least about 50 mm.

In some embodiments, housing 11 has a volume of up to about 2500 cubic centimeters and/or up to about 1500 cubic centimeters. In some of these embodiments, housing 11 has a volume of up to about 1000 cubic centimeters and/or up to about 600 cubic centimeters.

While described with regards to a handheld device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, etc.

Device 100 may be configured to provide voice and/or data communications functionality through wireless access points (WAPs) in accordance with different types of wireless network systems. A wireless access point may comprise any one or more components of a wireless site used by device 100 to create a wireless network system that connects to a wired infrastructure, such as a wireless transceiver, cell tower, base station, router, cables, servers, or other components depending on the system architecture. Examples of wireless network systems may further include a wireless local area network (WLAN) system, wireless metropolitan area network (WMAN) system, wireless wide area network (WWAN) system (e.g., a cellular network), and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (PAN) system, such as a Bluetooth® system operating in accordance with the Bluetooth Special Interest Group (SIG) series of protocols.

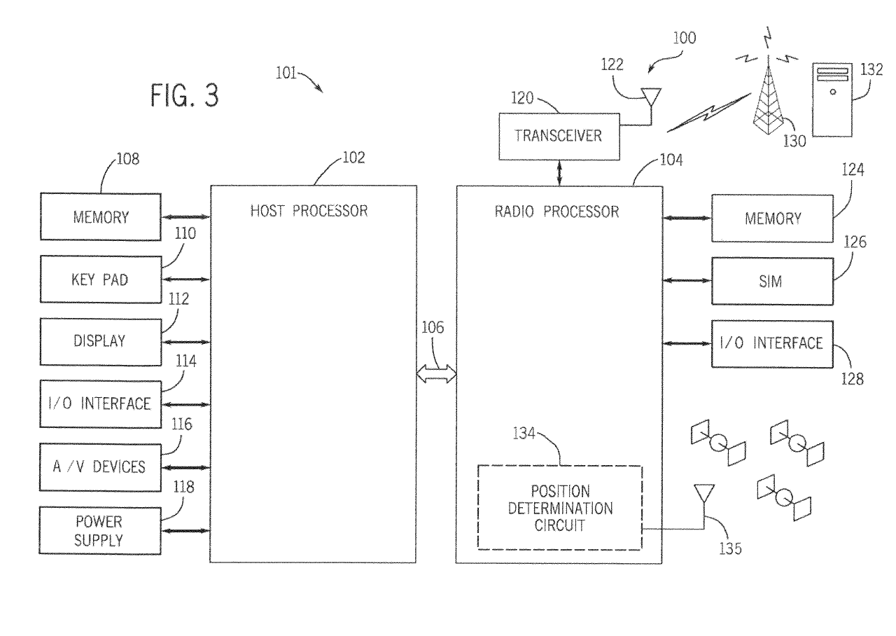

As shown in the embodiment of FIG. 3, device 100 may comprise a processing circuit 101 which may comprise a dual processor architecture, including a host processor 102 and a radio processor 104 (e.g., a base band processor). The host processor 102 and the radio processor 104 may be configured to communicate with each other using interfaces 106 such as one or more universal serial bus (USB) interfaces, micro-USB interfaces, universal asynchronous receiver-transmitter (UART) interfaces, general purpose input/output (GPIO) interfaces, control/status lines, control/data lines, shared memory, and so forth.

The host processor 102 may be responsible for executing various software programs such as application programs and system programs to provide computing and processing operations for device 100. The radio processor 104 may be responsible for performing various voice and data communications operations for device 100 such as transmitting and receiving voice and data information over one or more wireless communications channels. Although embodiments of the dual processor architecture may be described as comprising the host processor 102 and the radio processor 104 for purposes of illustration, the dual processor architecture of device 100 may comprise one processor, more than two processors, may be implemented as a dual- or multi-core chip with both host processor 102 and radio processor 104 on a single chip, etc. Alternatively, processing circuit 101 may comprise any digital and/or analog circuit elements, comprising discrete and/or solid state components, suitable for use with the embodiments disclosed herein.

In various embodiments, the host processor 102 may be implemented as a host central processing unit (CPU) using any suitable processor or logic device, such as a general purpose processor. The host processor 102 may comprise, or be implemented as, a chip multiprocessor (CMP), dedicated processor, embedded processor, media processor, input/output (I/O) processor, co-processor, a field programmable gate array (FPGA), a programmable logic device (PLD), or other processing device in alternative embodiments.

The host processor 102 may be configured to provide processing or computing resources to device 100. For example, the host processor 102 may be responsible for executing various software programs such as application programs and system programs to provide computing and processing operations for device 100. Examples of application programs may include, for example, a telephone application, voicemail application, e-mail application, instant message (IM) application, short message service (SMS) application, multimedia message service (MMS) application, web browser application, personal information manager (PIM) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (GUI) to communicate information between device 100 and a user.

System programs assist in the running of a computer system. System programs may be directly responsible for controlling, integrating, and managing the individual hardware components of the computer system. Examples of system programs may include, for example, an operating system (OS), device drivers, programming tools, utility programs, software libraries, an application programming interface (API), graphical user interface (GUI), and so forth. Device 100 may utilize any suitable OS in accordance with the described embodiments such as a Palm OS®, Palm OS® Cobalt, Microsoft® Windows OS, Microsoft Windows® CE, Microsoft Pocket PC, Microsoft Mobile, Symbian OS™, Embedix OS, Linux, Binary Run-time Environment for Wireless (BREW) OS, JavaOS, a Wireless Application Protocol (WAP) OS, and so forth.

Device 100 may comprise a memory 108 coupled to the host processor 102. In various embodiments, the memory 108 may be configured to store one or more software programs to be executed by the host processor 102. The memory 108 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), or any other type of media suitable for storing information.

Although the memory 108 may be shown as being separate from the host processor 102 for purposes of illustration, in various embodiments some portion or the entire memory 108 may be included on the same integrated circuit as the host processor 102. Alternatively, some portion or the entire memory 108 may be disposed on an integrated circuit or other medium (e.g., hard disk drive) external to the integrated circuit of host processor 102. In various embodiments, device 100 may comprise an memory port or expansion slot 123 (FIG. 1) to support a multimedia and/or memory card, for example. Processing circuit 101 may use memory port 123 to read and/or write to a removable memory card having memory, for example, to determine whether a memory card is present in port 123, to determine an amount of available memory on the memory card, to store subscribed content or other data or files on the memory card, etc.

Device 100 may comprise a user input device 110 coupled to the host processor 102. The user input device 110 may comprise, for example, a alphanumeric, numeric or QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons a volume rocker switch, a ringer on off switch having a vibrate mode, a keypad and so forth.

The host processor 102 may be coupled to a display 112. The display 112 may comprise any suitable visual interface for displaying content to a user of device 100. For example, the display 112 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

Device 100 may comprise an input output (I/O) interface 114 coupled to the host processor 102. The I/O interface 114 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, device 100 may be configured to transfer and or synchronize information with the local computer system.

The host processor 102 may be coupled to various audio/video (A/V) devices 116 that support A/V capability of device 100. Examples of A/V devices 116 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 118 configured to supply and manage power to the elements of device 100. In various embodiments, the power supply 118 may be implemented by a rechargeable battery, such as a removable and rechargeable lithium ion battery to provide direct current (DC) power, and/or an alternating current (AC) adapter to draw power from a standard AC main power supply.

As mentioned above, the radio processor 104 may perform voice and/or data communication operations for device 100. For example, the radio processor 104 may be configured to communicate voice information and/or data information over one or more assigned frequency bands of a wireless communication channel. In various embodiments, the radio processor 104 may be implemented as a communications processor using any suitable processor or logic device, such as a modem processor or baseband processor. Although some embodiments may be described with the radio processor 104 implemented as a modem processor or baseband processor by way of example, it may be appreciated that the embodiments are not limited in this context. For example, the radio processor 104 may comprise, or be implemented as, a digital signal processor (DSP), media access control (MAC) processor, or any other type of communications processor in accordance with the described embodiments. Radio processor 104 may be any of a plurality of modems manufactured by Qualcomm, Inc. or other manufacturers.

Device 100 may comprise a transceiver 120 coupled to the radio processor 104. The transceiver 120 may comprise one or more transceivers configured to communicate using different types of protocols, communication ranges, operating power requirements, RF sub-bands, information types (e.g., voice or data) use scenarios, applications, and so forth. For example, transceiver 120 may comprise a Wi-Fi transceiver and a cellular or WAN transceiver configured to operate simultaneously.

The transceiver 120 may be implemented using one or more chips as desired for a given implementation. Although the transceiver 120 may be shown as being separate from and external to the radio processor 104 for purposes of illustration, in various embodiments some portion or the entire transceiver 120 may be included on the same integrated circuit as the radio processor 104.

Device 100 may comprise an antenna system 122 for transmitting and/or receiving electrical signals. As shown, the antenna system 122 may be coupled to the radio processor 104 through the transceiver 120. The antenna system 122 may comprise or be implemented as one or more internal antennas and/or external antennas.

Device 100 may comprise a memory 124 coupled to the radio processor 104. The memory 124 may be implemented using one or more types of machine-readable or computer-readable media capable of storing data such as volatile memory or non-volatile memory, removable or non-removable memory, erasable or non-erasable memory, writeable or re-writeable memory, etc. The memory 124 may comprise, for example, flash memory and secure digital (SD) RAM. Although the memory 124 may be shown as being separate from and external to the radio processor 104 for purposes of illustration, in various embodiments some portion or the entire memory 124 may be included on the same integrated circuit as the radio processor 104. Further, host processor 102 and radio processor 104 may share a single memory.

Device 100 may comprise a subscriber identity module (SIM) 126 coupled to the radio processor 104. The SIM 126 may comprise, for example, a removable or non-removable smart card configured to encrypt voice and data transmissions and to store user-specific data for allowing a voice or data communications network to identify and authenticate the user. The SIM 126 also may store data such as personal settings specific to the user.

Device 100 may comprise an I/O interface 128 coupled to the radio processor 104. The I/O interface 128 may comprise one or more I/O devices to enable wired (e.g., serial, cable, etc.) and or wireless (e.g., WiFi, short range, etc.) communication between device 100 and one or more external computer systems.

In various embodiments, device 100 may comprise location or position determination capabilities. Device 100 may employ one or more position determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

In various embodiments, device 100 may comprise dedicated hardware circuits or structures, or a combination of dedicated hardware and associated software, to support position determination. For example, the transceiver 120 and the antenna system 122 may comprise GPS receiver or transceiver hardware and one or more associated antennas coupled to the radio processor 104 to support position determination.

The host processor 102 may comprise and/or implement at least one LBS (location-based service) application. In general, the LBS application may comprise any type of client application executed by the host processor 102, such as a CPS application, configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (POI) such as restaurants, hotels, landmarks, and entertainment venues, and other types of LBS services in accordance with the described embodiments.

Radio processor 104 may be configured to invoke a position fix by configuring a position engine and requesting a position fix. For example, a position engine interface on radio processor 104 may set configuration parameters that control the position determination process. Examples of configuration parameters may include, without limitation, location determination mode (e.g., standalone, MS-assisted, MS-based), actual or estimated number of position fixes (e.g., single position fix, series of position fixes, request position assist data without a position fix), time interval between position fixes, Quality of Service (QoS) values, optimization parameters (e.g., optimized for speed, accuracy, or payload), PDE address (e.g., IP address and port number of LPS or MPC), etc. In one embodiment, the position engine may be implemented as a QUALCOMM® gpsOne® engine.

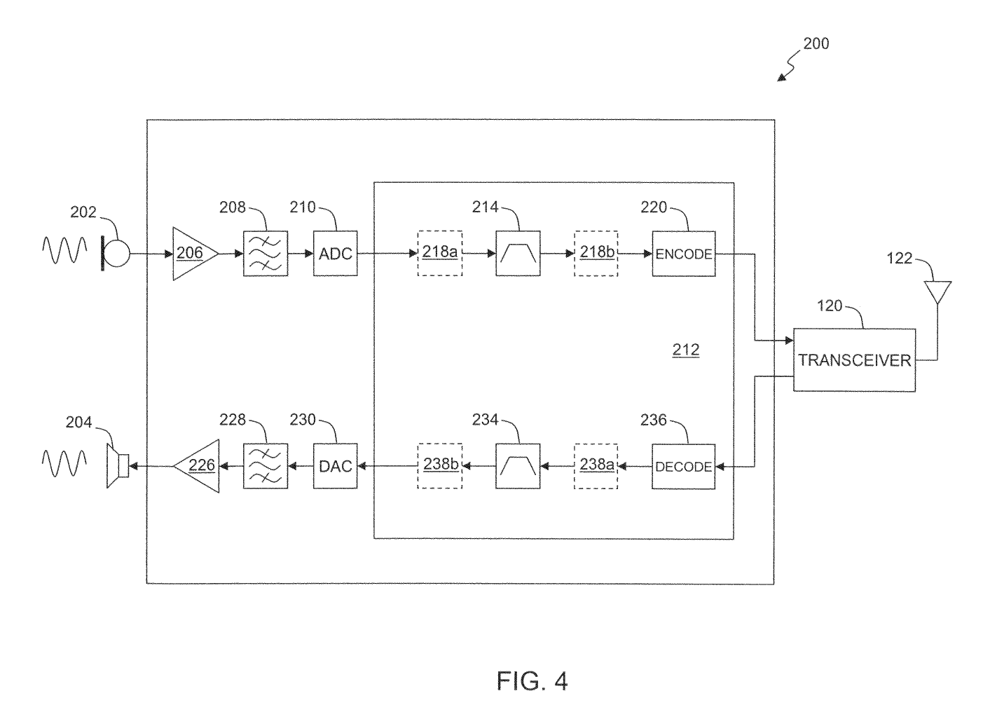

Referring now to FIG. 4, a block diagram of an exemplary audio processing portion of a mobile communication device for processing audio input signals will be described. A mobile communication device, such as the mobile computing device 100 described above, may include an audio processor 200 configured to process audio signals, such as speech signals The exemplary audio processor 200 receives an input audio signal form a first audio device, such as a microphone 202. The microphone 202 is an acoustic-to-electric transducer that converts sound into an electrical signal, The electrical signal is referred to as an audio input and may represent speech as in an audio speech signal. At least for voice frequencies, the microphone 202 preferably provides a faithful representation of a speaker's voice. The device 100 includes further provisions for processing the audio input signal, as may be necessary for quality and format, before providing the processed audio input signal to the transceiver 120 for further processing, and transmitted to a remote destination through the antenna system 122.

In some embodiments, the device 100 includes a transmit audio amplifier 206, a transmit audio filter 208, and an analog-to-digital converter (ADC) 210, which together condition the transmit speech signal for further processing by a digital signal processor (DSP) 212. The transmit audio amplifier 206 receives the input audio signal from the microphone 202 and amplifies it as may be necessary. The transmit audio filter 208 may be a low pass, a high pass, a band pass, or a combination of one or more of these filters for filtering the amplified transmit speech signal. The transmit audio amplifier 206 and transmit audio filter 208 function together to precondition the signal by reducing noise and level balancing prior to analog-to-digital conversion. The ADC 210 converts the pre-conditioned input audio signal into a digital representation of the same, referred to herein as a digitized input audio signal.

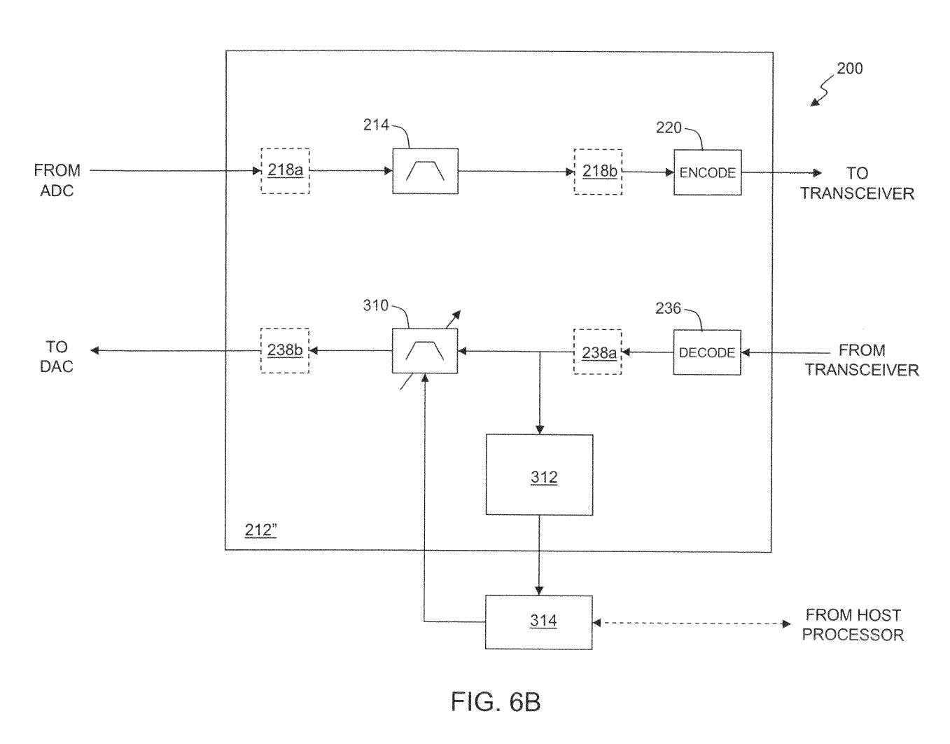

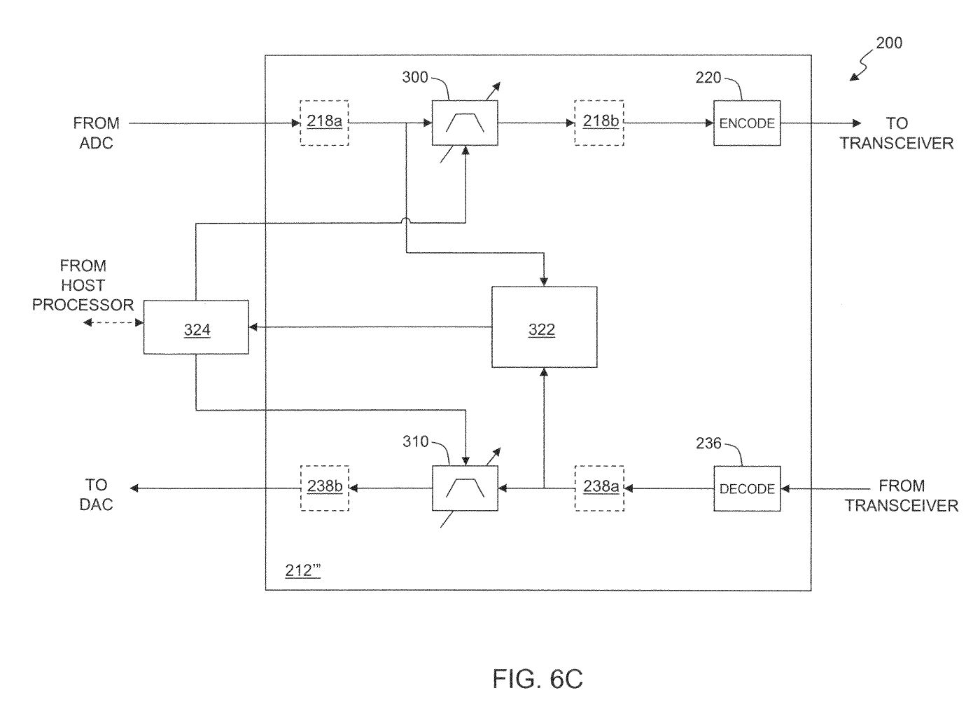

The DSP 212 provides further processing of the digitized input audio signal. For example, the DSP may include a filter 214 for adjusting a frequency response of the digitized input audio signal. Such spectral shaping filter 214 can be used for adjusting the digitized input audio signal as may be required to ensure that the signal conforms to a preferred transmit frequency mask. Such transmit frequency masks may be described by industry groups or standards committees. Exemplary transmit masks are described by the Cellular Telecommunications & Internet Association (CITA) (see, for example, FIG. 6.2 of the CTIA Performance Evaluation Standard for AMPS Mobile Stations, May 2004), or by the 3rd Generation Partnership Project (3GPP).

In some embodiments, the device 100 also includes a digital-to-analog converter (DAC) 230, a receive audio filter 228, and a receive audio amplifier 226, which together condition a received speech signal, prior to being converted to an audible response in a speaker 204. A signal is received through the antenna system 122, processed by the transceiver 120 to produce a received audio signal and forwarded to the audio processor 200. The received signal is processed by the DSP 212, which may include a decoder 236 to decode the previously encoded signal, as may be required. The decoded signal may be filtered by a spectral shaping filter 234 provided within the DSP 212. The DSP 212 may include one or more additional elements 238a, 238b (shown in phantom) implementing functions for further processing the received audio signal. As illustrated, these additional elements can be implemented before the filter 214, after the filter 214, or both before and after the filter 214.

The DAC 230 converts the DSP-processed audio signal into an analog representation of the same, referred to herein as a receive audio signal. A receive audio filter 228 may be a low pass, a high pass, or a band pass filter for filtering the received audio signal. A receive audio amplifier 226 amplifies the receive audio signal as may be necessary. Together, the receive audio amplifier 226 and receive audio filter 228 further condition the receive audio signal by reducing noise and level balancing prior conversion to sound by the speaker 204.

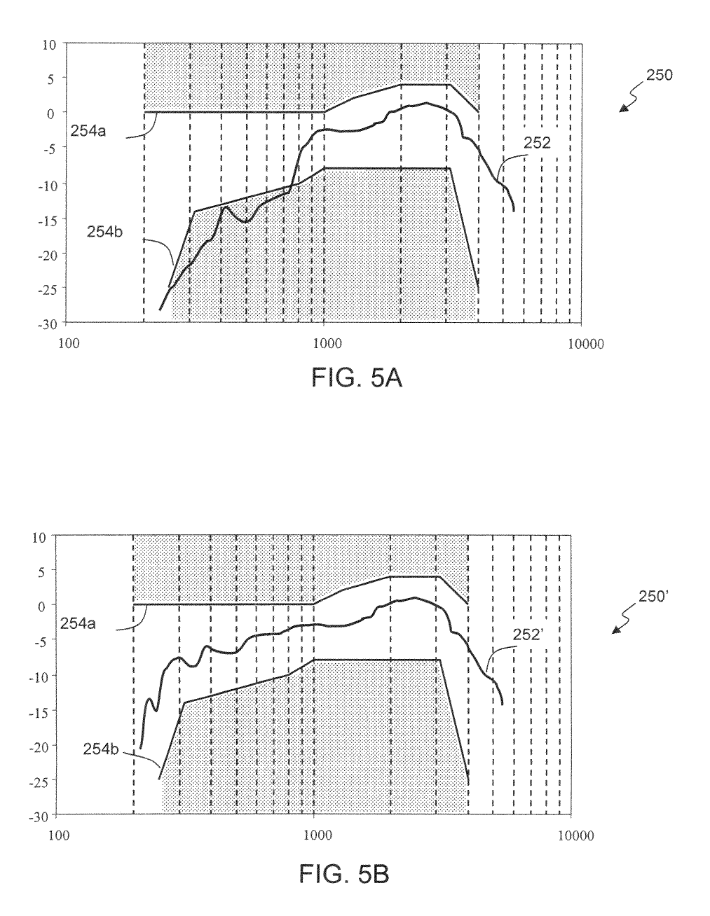

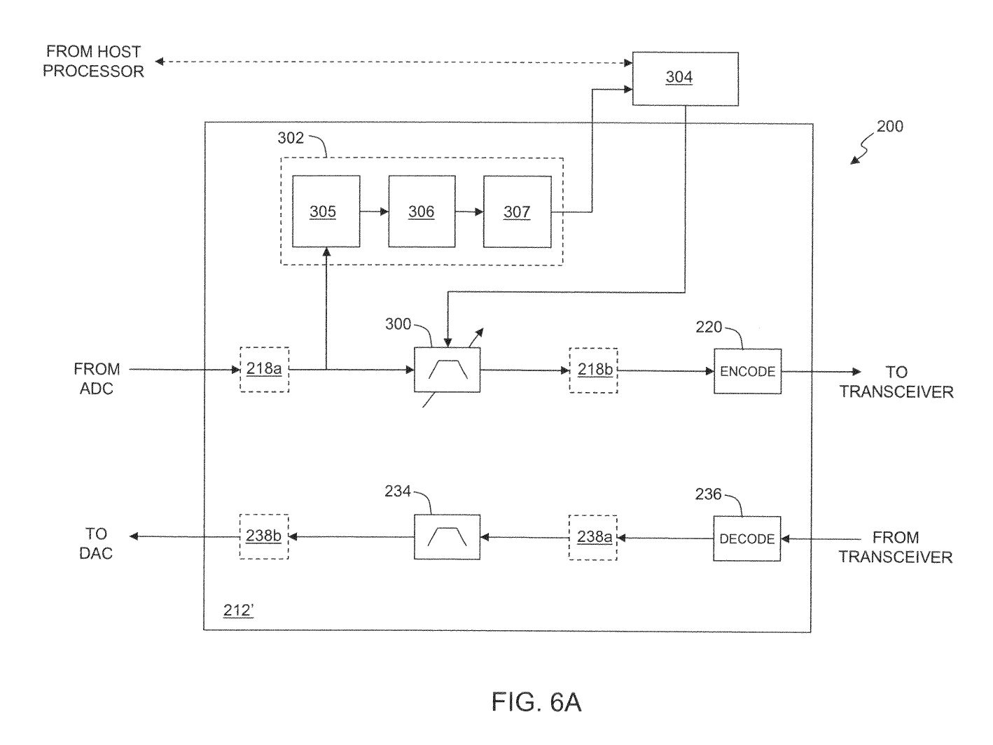

Referring now to FIG. 5A and FIG. 5B together, graphs illustrating exemplary spectral responses of an input audio signal processed by a mobile communication device will be described. Referring first to FIG. 5A, an audio frequency response 252 of an unfiltered transmit audio signal is illustrated together with an exemplary transmit audio frequency mask. The audio frequency mask includes upper and lower limits 254a, 254b (generally 254) that vary with frequency according to a predetermined standard, such as the CTIA standard transmit frequency mask. In the exemplary embodiment, the vertical scale represents a decibel value of the input audio signal levels relative to the input audio signal level at 1,000 Hz. The horizontal scale represents a logarithmic scale frequency, ranging from 100 to 10,000 Hz. In the exemplary embodiment, the lower frequencies of the input audio signal (i.e., below about 750 Hz) fall below the lower limit of the transmit audio frequency mask. To transmit such a signal would not adhere to the particular standard and would very likely result in a lack of intelligibility, or at the very least a less than optimal quality when reproduced at the call's destination.

A filter, such as the bandpass filter 214 (FIG. 4) can be configured to adjust the spectrum of the transmit audio signal, such as the exemplary audio frequency response 252 of FIG. 5A to compensate for its weak lower frequency response. For example, the bandpass filter 214 can be configured to attenuate frequencies above about 750 Hz by a value of about or at least 10 dB. The filter response can be tailored as appropriate using techniques of filter synthesis generally known to those skilled in the art. Referring next to FIG. 5B, a tailored audio frequency response 252′ of the filtered transmit audio signal is illustrated together with the same transmit audio frequency mask 254. The resulting filtering process has effectively raised the lower frequencies by attenuating the higher frequencies, such that the tailored, or filtered transmit audio signal 252′ falls well within the transmit audio frequency mask 254 across the performance spectrum of about 200 Hz to about 4 kHz.

As described above, some systems include a fixed filter 214, 234 having a pre-selected spectral profile based on a compromise audio input signal, such as the ITU P.50 signal, rather than an actual audio input signal. The compromise signal does not correspond to any particular speaker, but rather to some average signal; representative of a range of different speakers. The result can be less than desirable as the fixed filter 214 (FIG. 4) may result in portions of an actual audio input signal that may have otherwise been within the audio frequency mask to be driven beyond limits set by the mask 254. The result can lead to the very same loss of quality and perhaps intelligibility that the filter was intended to correct.

In practice, the DSP 212 can be based on a microprocessor, programmable DSP processor, application-specific hardware, or a mixture of these. The digital processor implements one or several DSP algorithms. The basic DSP operations may include convolution, correlation, filtering, transformations, and modulation. Using these basic operations, those skilled in the art will realize that more complex DSP algorithms can be constructed for a variety of applications, such as speech coding.

Referring now to FIG. 6A, a block diagram of an alternative embodiment of the audio processing portion of a mobile communication device of FIG. 4 will be described. The audio processor 200 includes DSP 212′ configured with an adaptable filter 300 adapted to provide more than one frequency selectivity profile. The DSP 212′ also includes an audio signal analyzer 302. The audio signal analyzer 302 receives a pre-filtered sample of the digitized audio speech signal. The audio signal analyzer 302 performs a signal analysis of the speech signal to identify or determine one or more features, patterns, or characteristics of the speech signal. The identified characteristics correspond to at least some aspects of a particular speaker's voice and therefore are indicative of the particular user. Accordingly, these characteristics can be used to identify an individual user. Alternatively or in addition, these characteristics can be used to identify a particular class of users with which the individual user is associated.

The signal analyzer 302 is coupled to a filter selector 304. Results of the signal analysis are forwarded to the filter selector 304, which is further coupled to the adaptable filter 300. The filter selector 304 provides an output to the adaptable filter 300, which is configured to alter a selectivity profile of the filter according to the received filter selector output. Thus, the adaptable filter 300 is reconfigured in response to the audio speech signal. The filter selector 304 output can be used to select a particular filter from a number of different predetermined or prestored filters, each filter having a respective filter profile. Alternatively or in addition, filter selector 304 output can be used to configure a reconfigrable adaptive filter 300. For example, the adaptive filter 300 can be changed or reconfigured according to one or more filter coefficients. In some embodiments, the filter selector 304 output provides the one or more filter coefficients to the adaptable filter 300, which changes its filter selectivity profile in response to the received coefficients.

In some embodiments, the signal analyzer 302 includes a time-to-frequency converter 305, a spectrum tracker 306, and a signal characterizing module 307. The time-to-frequency converter 305 processes the digitized audio speech signal to produce a frequency spectrum representative of the speech signal. Such processing can be accomplished by taking a Fourier transform of the time-varying input signal. For example, the Fourier transform can be accomplished by a fast Fourier transform (FFT), using well-known algorithms to produce a frequency spectrum of the signal. For discrete time speech signals, the Fourier transform can be accomplished by a Discrete Fourier Transform (DFT). Still other techniques may use a discrete cosine transformation, or the like.

The resulting frequency spectrum can be divided into a number of sub bands by the spectrum tracker 306 The spectrum tracker can include a histogram of different frequency bands for multiple samples of the input signal. In an exemplary embodiment, an input frequency spectrum of about 100 Hz to about 4 kHz is divided into 13 frequency sub-bands, such that the spectral power levels can be determined for each of the individual sub bands In some embodiments, each of the sub bands spans a substantially equal frequency range. Alternatively or in additional, each of the sub bands can be determined to span an unequal frequency range. For example, each of the sub bands can be configured to span a respective portion of a logarithmic frequency scale.

The resulting amplitude values for each of the frequency ranges, individually or collectively, represent a characteristic, or signature of the sampled speech. Power levels for each of the respective sub bands obtained by the time-to-frequency converter 305 can be stored or otherwise combined with previous results for the same respective sub bands. For example, an average power level can be determined for each sub band. With successive FFTs, previously stored average spectral power levels can be re-averaged considering successive values to maintain a current average value. By averaging multiple samples together, the spectrum tracker 306 generates and maintains an average power spectral density. The averaging can be performed over a limited number of samples, or continuously.

A signal characterizing module 307 receives a representation of the averaged power spectral density, and determines spectral coefficients representative of the power spectral density. For example, the signal characterizing module 307 reads a representative value from each sub band of the histogram generated by the spectrum tracker 306. The resulting spectral coefficients are generally different for each individual user, or speaker and are therefore indicative of the speaker's voice.

In alternative embodiments, the signal analyzer 302 processes the digitized audio input signal using acoustic features of the speech to distinguish among different speakers. Such techniques can be referred to as voice recognition, for distinguishing vocal features that may result from one or more of anatomical differences (e.g., size and shape of a speaker's throat and mouth) and learned behavioral differences (e.g., voice pitch, speaking style, language). Thus, a speaker can be distinguished individually, or according to categories, such as male, female, adult, child, etc., according to distinguishable ranges of one or more acoustic features of the speaker's voice. Various technologies can be used to process voice patterns, such as frequency estimation, hidden Markov models, pattern matching algorithms, neural networks, matrix representation, and decision trees.

Alternatively or in addition, features of the audio speech signal can be determined using a so called cepstral analysis. For example, the signal analyzer 302 processes the digitized audio input signal using cepstral analysis to produce a cepstrum representative of the input signal. The time-to-frequency converter 305 can obtain a cepstrum of the audio clip by first determining a frequency spectrum of the input signal (e.g., using a Fourier transfer, FFT, or DFT as described above) and then taking another frequency transform of the resulting spectrum as if it were a signal. For example, power spectral results determined by a first FFT can be converted to decibel values by taking a logarithm of the results. The resulting logarithm can be further transformed using a second FFT to produce the cepstrum.

In some embodiments, the cepstral analysis is performed according to a so called “mel” scale based on pitch comparisons. The mel-frequency cepstrinm uses logarithmically positioned frequency bands, which better approximate the human auditory response, compared to linear scales.

In an exemplary embodiment, a mel-frequency cepstrum of an audio clip is determined by taking a Fourier transform of a signal. This can be realized using a windowed excerpt of the signal. The resulting log amplitudes of the Fourier spectrum are then mapped onto a mel-frequency scale. Such mapping can be obtained using triangular overlapping windows. A second transform, such as a discrete cosine transform can then be performed on the list of mel-log amplitudes, as if it were a signal, resulting in a mel-frequency cepstrum of the original audio signal. The resulting amplitudes can be referred to as mel-frequency cepstral coefficients, which are indicative of a speech pattern.

Power levels for each of the respective cepstral sub bands (e.g., the mel-frequency cepstral coefficients) can also be stored or otherwise combined with previous results for the same respective sub bands. For example, an average power level can be determined for each cepstral sub band. With similar processing of successive samples, previously stored average cepstral power levels can be re-averaged considering successive values to maintain a current average value. By averaging multiple samples together, the spectrum tracker 306 generates and maintains an average cepstrum. The averaging can be performed over a limited number of samples, or continuously.

For cepstral processing, the signal characterizing module 307 receives a representation of the cepstrum, and determines the mel-frequency cepstral coefficients. The resulting mel-frequency cepstral coefficients are generally different for each individual user and are therefore also indicative of the user's voice.

In some embodiments, the signal analyzer 302 produces a real-valued cepstrum using real-valued logarithm functions. The real-valued cepstrum uses information of the magnitude of the frequency spectrum of the input audio signal. Alternatively or in addition, the signal analyzer 302 produces a complex-valued cepstrum using complex-valued logarithm functions. The complex-valued cepstrum uses information of the magnitude and phase of the frequency spectrum of the input audio signal. The cepstrum can be seen as providing information about rate of change in the different spectrum bands and provides further means for characterizing the underlying speaker's voice.

In an exemplary embodiment, the filter selector 304 receives mel-frequency cepstral coefficients obtained by the signal characterizing module 307, and performs a filter selection responsive to the obtained coefficients. The filter selector 304 selects a filter profile according to the one or more of the coefficients to configure the adaptive filter 300 for providing an improved overall audio response. In some embodiments, the filter selector 304 implements logic to compare one or more of the coefficients to respective threshold values, the resulting filter selection depending upon the results of the comparison.

Continuing with the 13 sub-band example, one or more of the lower frequency coefficients can be combined for a representative low frequency response. Alternatively or in addition, one or more of the higher frequency coefficients can be combined for a representative high frequency response. Each of the representative low and high frequency response values can be compared to a respective low and high frequency threshold. The results of such an example would distinguish between at least two, to as many as four different categories of user: deep voice, high-pitched voice, loud, and soft. The filter selector 304 can select a filter based on one or more of the resulting comparisons. Alternatively or in addition, different numbers of the coefficients can be compared against respective thresholds for greater flexibility and granularity. In some embodiments, the filter selector 304 compares one or more of the speech characteristics (e.g., the mel-frequency cepstrum coefficients) to each of one or more reference speech characteristics.

In some embodiments, the audio processor 200 implements such an algorithm to determine the voice characteristics of the individual speaker associated with the audio input signal. For example, upon determining a user has a deep voice, a filter selection can be made to boost higher frequencies, attenuate lower frequencies, or a combination of both to produce a resulting processed audio signal that is not “muddy,” providing greater intelligibility. Similarly, if the filter selection process 304 determines the user has a high-pitched voice, a different filter selection can be made to boost lower frequencies, attenuate higher frequencies, or a combination of both to produce a resulting processed audio signal that is not “tinny,” again providing greater intelligibility.

A resulting filter selection is based upon which of the one or more reference speech characteristics is best matched. For example, a reference speech characteristics is stored for each of a number of different individual speakers, or categories of speakers. An associated filter selection is also stored according to each of the individual speakers, or categories of speakers. Thus, once a determination is made associating a sampled audio speech signal with a respective one of the one or more different individual speakers, or categories of speakers, the filter selector 304 selects an appropriate filter based on the filter response associated with the identified speakers, or category of speakers.

In some embodiments, the filter selector 304 is in communication with the host processor. In some embodiments, one or more functions of the filter selector 304 can be implemented by the host processor. The particular filter selection depends, at least to some degree, on the type of adaptive filter 300.

In some embodiments, the adaptive filter 300 is an adjustable filter capable of providing a variable selectivity profile depending on the particular adjustment. Alternatively or in addition, the adaptive filter 300 includes more than one filter. Each of the multiple filters can be configured with a respective selectivity profile, and with one of the multiple filters being selected for use at any given time. Although the exemplary embodiments described herein use DSP operating on digitized audio signals, it is envisioned that the audio processor may alternatively include analog processing, or a combination of analog and digital processing. The filters can be analog, digital or a combination of analog and digital, depending upon whether the audio processor is using DSP, analog processing, or a combination of DSP and analog processing.

For digital embodiments, the adaptive filter 300 can include one or more infinite impulse response (11R) filters, finite impulse response (FIR) filters, or recursive filters. The digital filters of the adaptive filter 300 can be implemented in DSP, in computer software, or in a combination of DSP and computer software. For analog embodiments, the one or more filters of the adaptive filter 300 can include one or more of low pass, high pass, and band pass filters. The individual filters can be configured to have common filter responses, such as Butterworth, Chebyshev, Bessel type, and elliptical filter responses. These filters can be constructed using combinations of one or more of resistors, capacitors, inductors, and active components, such as transistors and operational amplifiers, using filter synthesis techniques known to those skilled in the art.

Referring now to FIG. 6B, a block diagram of another alternative embodiment of an audio processing portion of a mobile communication device of FIG. 4 will be described. In this embodiment, an audio processor 212″ includes an adaptive filter 310 in a received audio path. The audio processor 212″ includes a received signal analyzer 312, and a filter selector 314. Each of the received signal analyzer 312 and the filter selector 314 can implement any of the functionality described above with respect to the signal analyzer 302, and a filter selector 304 of the transmit audio signal path 212′ (FIG. 6A).

Referring now to FIG. 6C, a block diagram of yet another alternative embodiment of an audio processing portion of a mobile communication device of FIG. 4 will be described. In this embodiment, an audio processor 212′″ includes an adaptive filter 300 in a transmit audio path another adaptive filter 310 in a received audio path. The audio processor 212′″ includes a signal analyzer 322, and a filter selector 324. Each of the signal analyzer 322 and the filter selector 324 can implement any of the functionality described above with respect to the signal analyzer 302, and a filter selection process 304 of the transmit audio signal path (FIG. 6A), and the signal analyzer 312, and a filter selection process 314 of the receive audio signal path (FIG. 6B). Although single received signal analyzer 322 and filter selection process 324 are shown, one or both of these can be implanted separately for each of the transmit and receive audio paths.

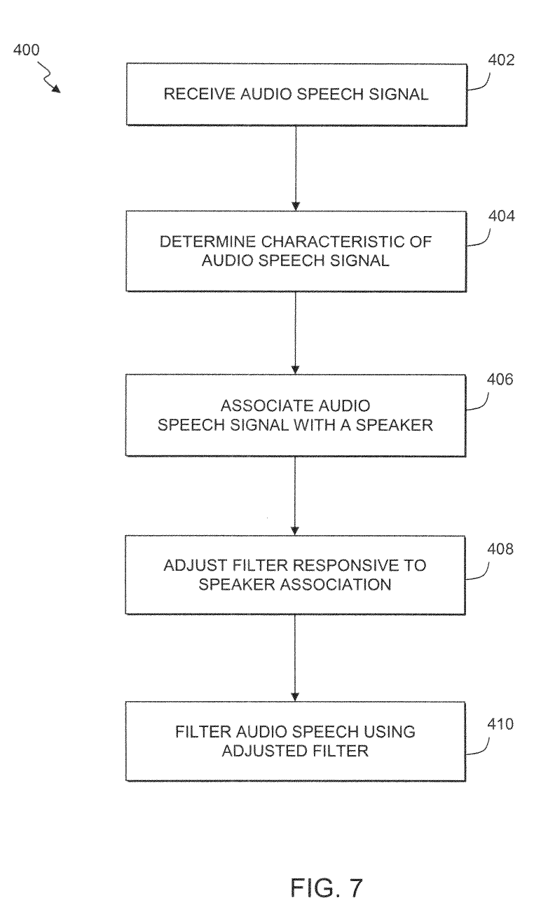

Referring now to FIG. 7, a flowchart illustrating a system and method of processing a speech signal, according to an exemplary embodiment will be described. An audio speech signal is received from a user at step 402. At least one characteristic of the received speech signal is determined at step 404. The audio speech signal is associated with a speaker at step 406. An adaptive filter is adjusted according to the determined speaker at step 408. The audio speech signal is processed by the adjusted filter at step 410, for improved performance according to the determined characteristic. Thus, once voice characteristics have been determined and associated with an individual speaker, or category of speaker, a preferred filter profile is determined according to the associated speaker/category of speakers, and the adaptive filter is set accordingly to compensate as may be required.

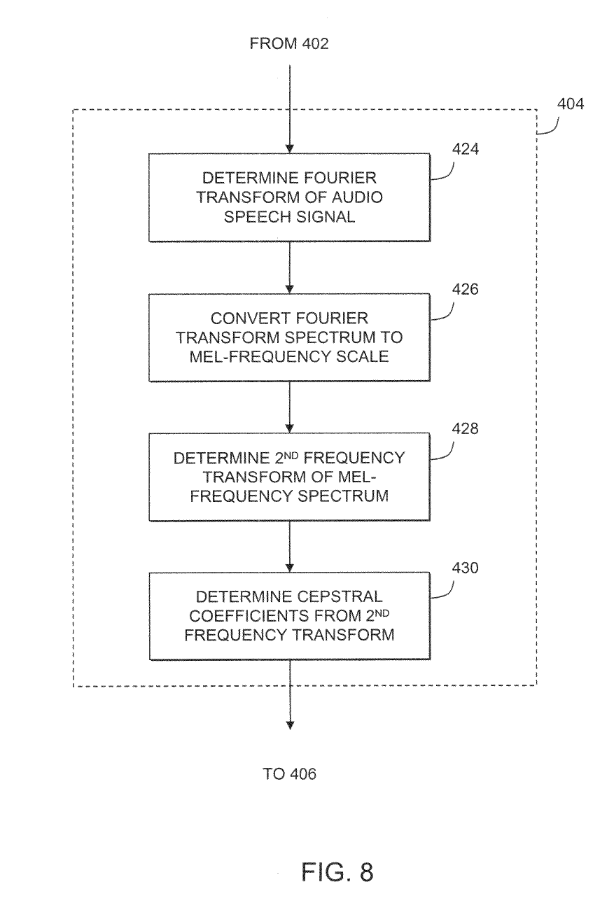

Referring now to FIG. 8, a flowchart illustrating step 404 (FIG. 7) of determining a characteristic of an audio speech signal will be described in more detail, according to an exemplary embodiment. An audio speech signal is received at step 402. The audio speech signal is analyzed at step 404. The audio speech signal is Fourier transformed at step 424. The resulting Fourier spectrum is converted to a mel-frequency scale at step 426. A second frequency transform of the mel-frequency spectrum is performed at step 428. Mel-frequency cepstral coefficients are determined from the second frequency transform at step 430. The mel-frequency cepstral coefficients to the extent they represent a speech pattern are indicative of an individual speaker, or at least a particular category of speaker categories. Accordingly, the mel-frequency cepstral coefficients can be used to associate the audio speech signal with an individual speaker, or category of speakers.

In some embodiments, characteristics of audio speech signals used for comparison in identifying a speaker as an particular speaker or category of speakers, are pre-stored in a mobile communication device. For example, mel-frequency cepstral coefficients indicative of a male speaker and a female speaker can be pre-stored in memory 124 of the device. Mel-frequency cepstral coefficients obtained from a speaker are then compared to these pre-stored values, such that an association is made to the closer of the pre-stored values as described herein. Once the associate has been made, the audio filter is selected according to the association (i.e., male or female) to process the speakers audio speech signals thereby enhancing quality. The above process can be performed once, for example upon initiation of a call, repeatedly at different intervals during a call, or as part of a substantially continuous or semi-continuous process that adjusts and readjusts the adapter filter as may be required to preserve audio quality and intelligibility throughout a call.

In some embodiments, the filter selection once made is stored for future use. For example, the last selection of the filter may be stored and used upon initiation of a new call. The process filter adjustment process can thus be performed from an initial filter setting determined from a last filter setting. If the mobile communication device is used by the same person, the last setting should be a very good starting point for a new call. If a different user should initiate a call, however, the audio processor will determine new coefficients as described above, making a new filter selection as may be necessary.

In some embodiments, speaker characteristics (e.g., mel-frequency cepstral coefficients) in the form of speaker models can be stored for one or more speakers. The models can be adapted after each successful identification to capture long term change. This may be advantageous for a phone used by different individuals, such as different family members Thus, upon initiation of a call, the signal analyzer determines spectral or cepstral coefficients, as the case may be, makes an association to one of the one or more speakers, and selects an appropriate filter according to the associated speaker.

In some embodiments, such filter selections can be stored or otherwise linked to an address book. Thus, if a call is placed or received to another remote user previously determined to have a deep voice, the receive audio processor is preset a received audio filter selection that provides suitable quality and intelligibility for the individual associated with the particular number. If a different individual happens to answer and engage in a conversation, the receive audio filter can be reconfigured as described above. Filter settings for any of the individuals can be resaved at any point.

While the exemplary embodiments illustrated in the Figs., and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A method for processing an audio speech signal, comprising:
determining at least one characteristic of an audio speech signal;
associating the audio speech signal with a speaker in response to determination of the at least one characteristic; and
configuring a filter based on the associated speaker; and
applying the filter to the audio speech signal.

2. The method of claim 1, wherein the act of determining at least one characteristic of an audio speech signal comprises determining a frequency spectrum of the audio speech signal.

3. The method of claim 1, wherein the act of associating the audio speech signal with a speaker comprises comparing at least a portion of the frequency spectrum of the audio speech signal to a speaker profile, the resulting comparison indicative of a profiled speaker.

4. The method of claim 1, wherein the act of determining at least one characteristic of an audio speech signal comprises determining a frequency cepstrum of the audio speech signal.

5. The method of claim 4, wherein the act of determining the frequency cepstrum comprises:
obtaining a frequency spectrum of the audio speech signal;
determining a logarithmic amplitude of the frequency spectrum; and
performing a frequency transformation of the logarithmic amplitude frequency spectrum, yielding a frequency cepstrum of the audio speech signal.

6. The method of claim 4, wherein the act of associating the audio speech signal with a speaker comprises comparing at least a portion of the frequency cepstrum of the audio speech signal to a speaker profile, the resulting comparison indicative of a profiled speaker.

7. The method of claim 1, wherein the act of selecting a filter based on the associated speaker comprises adjusting an adjustable filter.

8. The method of claim 1, wherein the act of selecting a filter based on the associated speaker comprises providing coefficients to a digital filter.

9. The method of claim 1, wherein at least one of the acts is performed in a digital signal processor.

10. A mobile communications device for processing an audio speech signal, comprising:
signal analyzer receiving at least a sample of an audio speech signal and determining at least one characteristic feature thereof;
signal characterizing module receiving from the signal analyzer the at least one characteristic feature of the at least one sample of the audio speech signal, and associating therewith a speaker; and
a filter selector selecting a filter based on the associated speaker, wherein the selected filter provides a listener with an improved audio experience.

11. The mobile communications device of claim 10, wherein at least one of the signal analyzer, the signal characterizing module, and the filter selector is implemented in a digital signal processor.

12. The mobile communications device of claim 10, further comprising a host processor implementing instructions related to at least one of the signal analyzer, the signal characterizing module, and the filter selector.

13. The mobile communications device of claim 10, wherein the signal analyzer is configured to determine a frequency spectrum of the audio speech signal.

14. The mobile communications device of claim 10, wherein the signal analyzer is configured to determine a frequency cepstrum of the audio speech signal.

15. The mobile communications device of claim 10, further comprising memory for storing at least one of sample of an audio speech signal, characteristic feature of the at least one sample, and filter selections.

16. The mobile communications device of claim 10, further comprising an adjustable filter in communication with the filter selector, the adjustable filter tailoring its filter profile responsive to the filter selection.

17. The mobile communications device of claim 16, wherein the adjustable filter comprises a digital filter.

18. The mobile communications device of claim 17, wherein the digital filter comprises a finite impulse response filter.

19. The mobile communications device of claim 10, wherein the mobile communications device is a cellular radiotelephone.

20. An apparatus for processing an audio speech signal, comprising:
means for determining at least one characteristic of an audio speech signal;
means for associating the audio speech signal with a speaker in response to determination of the at least one characteristic; and
means for selecting a filter based on the associated speaker, wherein the selected filter, when applied to the audio speech signal, provides a listener with an improved audio experience.
